(19) United States
(12) Patent Application Publication
(10) Pub. No.: US 2006/0198510 A1
(43) Pub. Date: Sep. 7, 2006

(54) Xdsl line quality control device, xdsl transmission method selection device, and xdsl line quality monitoring device

(76) Inventors: Shinichi Sakamoto, Kawasaki (JP); Hiroshi Funaki, Kawasaki (JP); Takashi Yamashita, Kawasaki (JP)

Correspondence Address: Stanley R Moore;Jenkens & Gilchrist, 1445 Ross Avenue, Suite 3200, Dallas, TX, 75202-2799, US

(21) Appl. No.: 10/543,969

(22) PCT Filed: Jan. 30, 2003
(86) PCT No.: PCT/JP03/00898

§ 371 Date: Jul. 28, 2005

(51) Int. Cl. H04M 1/00

(52) U.S. Cl. 379/399.01

(57) ABSTRACT

The invention is applied to an xDSL communications technology for connecting a user and a center to each other for mutual communication via a two-wire telephone line. Especially, xDSL is intended to increase the line quality and the transmission rate not by judging whether the line quality is high or low by monitoring only the signal-to-noise ratio (SNR) margin or only the signal attenuation factor (ATT) but by monitoring the following factors: (a) the interleave delay (complexity of error correction) and the interleave correction time (error correction time), (b) a CRC error, a loss-of-signal (LOS), and a loss-of-frame (LOF) monitored regularly from performance information, and (c) the transmission rate in addition to the signal-to-noise ratio (SNR) margin and the signal attenuation factor (ATT). The signal-to-noise ratio (SNR) margin, the signal attenuation factor (ATT), and the above factors (a) to (c) are monitored to improve line quality and transmission rate.

### TECHNICAL FIELD

The present invention is applied to an xDSL (x digital subscriber line) communications technology in which a user and a center are connected to each other via a two-wire telephone line for mutual communication, and it relates to an xDSL line quality control apparatus, an xDSL transmission system switching apparatus, and an xDSL line quality monitoring apparatus.

### BACKGROUND ART

As for a communication according to xDSL (ADSL (asymmetric DSL), SDSL (symmetric DSL), VDSL (very high bit rate DSL), HDSL (high bit rate DSL), or the like) using a two-wire telephone line, contention occurs between its frequency band and the frequency bands of existing communications technologies (telephone, analog modem communication, ISDN, etc.). As a result, the line quality of a communication according to xDSL is varied by interference between signals due to such frequency band contention. As such, xDSL is a communications technology in which it is difficult to maintain line quality at a certain level. In this connection, Japanese Unexamined Patent Application Publication No. 10-173650 discloses a technique that relates to transmission quality judgment.

To accommodate a situation that xDSL cannot maintain a certain level of transmission quality, the international standard ITU-T G.992.1 (G.dmit: Appnedix2) recommends as follows. That is, the standard recommends a line quality varying technique called “dynamic rate adaptation” for maintaining the best transmission quality in a constantly varying environment.

However, the technique described in Appnedix2 is an optional function and an apparatus incorporating it is complex and expensive. As such, this technique has not been implemented yet.

In such circumstances, a first conventional technique is employed in which the line quality is monitored by monitoring the signal-to-noise ratio (SNR) margin. The signal-to-noise ratio margin (unit: db) means a margin that is necessary for transmitting a signal correctly against varying noise. The line quality increases and the transmission rate decreases as the value of the signal-to-noise ratio margin increases. In other words, the line quality lowers and the transmission rate increases as the value of the signal-to-noise ratio margin decreases.

The above-mentioned standard Appnedix2 prescribes transmission systems FBM (FEXT bitmap) and DMB (dual bitmap).

In FBM, signal transmission and reception are not performed with NEXT (near end crosstalk) timing with which a telephone line is greatly influenced by ISDN and are performed only with FEXT (far end crosstalk) timing with which a telephone line is not greatly influenced by ISDN. More specifically, downstream signals and upstream signals are transmitted alternately one after another when FEXT timing occurs. The upstream signal is a signal that is transmitted from the user side to the center side, and the downstream signal is a signal that is transmitted from the center side to the user side. Therefore, FBM requires only a single bitmap that defines transmission quality allocation. The NEXT timing is timing for transmission of a signal from a center to a user in ISDN by a TCM system (time compression multiplexing transmission system). The FEXT timing is timing for transmission of a signal from a user to a center.

In DMB, two bitmaps, that is, a FEXT bitmap and a NEXT bitmap, are provided. The DMB enables signal transmission and reception even with NEXT timing that is not used in FBM by switching the bit map from the FEXT bit bitmap to the NEXT bitmap, which contributes to increase in transmission rate. That is, upstream signals and downstream signals are transmitted with both FEXT timing and NEXT timing.

Other, recently developed transmission systems such as DBMOL, FBMsOL, and XOL are also available, which are not prescribed by the above-mentioned standard Appnedix2.

In DBMOL (dual bitmap overlap), a frequency band that is prepared in DBM only for transmission of upstream signals (i.e., signals to be transmitted from the user side to the center side) is also allocated to downstream signals (i.e., signals to be transmitted from the center side to the user side). The allocation to downstream signals is done for both the FEXT bitmap and the NEXT bitmap. Therefore, the transmission rate of a downstream signal is increased in both a FEXT timing transmission and a NEXT timing transmission.

In FBMsOL (FEXT bitmap shaping overlap), the transmission rate is increased by allocating a frequency band that is prepared in FBM only for transmission of upstream signals (i.e., signals to be transmitted from the user side to the center side) with FEXT timing is also allocated to downstream signals. Therefore, downstream signals are transmitted by using the entire frequency band except a low-frequency band for telephone calls. A frequency band to be used for transmission upstream signals is the same as in FBM. Therefore, the transmission rate of a downstream signal is increased. In FBMsOL, the power consumption tends to increase. In view of this, the power is saved by power shaping.

In XOL (x overlap), in the FEXT timing, transmission and reception are performed without an overlap between frequency bands for upstream signals and downstream signals. In the NEXT timing, the transmission rate is increased by allocating a frequency band that is prepared for transmission of upstream signals also to downstream signals. The DBMOL, FBMsOL, and XOL transmission systems can realize a maximum transmission rate of 12 Mbps for a downstream signal.

FIG. 6 shows differences between the above transmission systems in the relationship between the distance and the transmission rate.

As shown in FIG. 6, DBMOL is a system in which the transmission rate is high in the case where the distance between a center and a user is short. However, DBMOL cannot be used for long-distance transmissions. As such, DBMOL is for short-distance users.

Conversely, FBMsOL is a system in which transmission is possible even if the distance between a center and a user is long. However, the transmission rate of FBMsOL is low. As such, FBMsOL is for long-distance users.

As shown in FIG. 6, each of the other transmission systems XOL, DBM, and FBM has its own feature in the relationship between the distance and the transmission rate.

In recent years, various systems have been proposed in the above transmission technology.

As mentioned above, to maintain the best transmission quality in a constantly varying environment, a second conventional technique has been proposed in which the signal attenuation factor is monitored and a proper one is selected from plural transmission systems in accordance with the attenuation factor.

However, the above-described conventional techniques have the following problems.

First, as for the monitoring of the line quality that is performed by monitoring only the signal-to-noise (SNR) margin, it is noted that noise not only occurs periodically but also happens suddenly on a line. Therefore, judging whether the line quality is high or low by monitoring only the signal-to-noise (SNR) margin is associated with problems.

Second, although it is possible to select a proper one from plural kinds of xDSL transmission systems by monitoring only the signal attenuation factor (ATT), selecting a transmission system by monitoring only the signal attenuation factor is problematic in performing a communication at a proper transmission rate.

### DISCLOSURE OF THE INVENTION

An object of the present invention is to increase the line quality and the transmission rate in xDSL not by judging whether the line quality is high or low by monitoring only the signal-to-noise (SNR) margin or the signal attenuation factor (ATT) but by monitoring the factors described below.

That is, the following factors are monitored in addition to the signal-to-noise (SNR) margin and the signal attenuation factor (ATT).

(a) The interleave delay (complexity of error correction) and the interleave correction time (error correction time) are monitored.

The interleave delay and the interleave correction time have the following relationship. For example, the capacity of a memory for storing signals is increased to increase the interleave delay. As a result, the accuracy of error correction is increased greatly and signal transmissions can be performed correctly. However, the interleave correction time (error correction time) becomes longer because of increase of the numbers of signals processed, and hence the transmission rate decreases.

(b) A CRC error, a loss-of-signal (LOS), and a loss-of-frame (LOF) are monitored on a regular basis from performance information.

Monitoring a CRC error, a loss-of-signal (LOS), and a loss-of-frame (LOF) event every prescribed period of time makes it possible to monitor the line quality and to issue an alarm.

(c) The transmission rate is monitored.

The line quality and the transmission rate are increased by monitoring the signal-to-noise ratio (SNR) margin, the signal attenuation factor (ATT), and the above factors (a)-(c).

All the monitoring described above can be performed at the center. On the user side, the signal-to-noise ratio (SNR) margin, the signal attenuation factor (ATT), and the monitoring of the transmission rate can be performed.

Specifically, the above object is attained in the following manners.

First, in an xDSL line quality control apparatus in which a user side and a center side are line-connected to each other by a two-wire telephone circuit and an xDSL communications technology and are thereby allowed to communicate with each other, a line quality monitoring section acquires a signal-to-noise ratio margin value, an attenuation factor, an interleave delay, an interleave correction time, and an access speed.

A line quality setting section sets the quality of the line to a certain level by newly setting a signal-to-noise ratio margin value, an attenuation factor, an interleave delay, an interleave correction time, and an access speed for a line to connect the user side and the center side according to the acquired signal-to-noise ratio margin value, attenuation factor, interleave delay, interleave correction time, and access speed.

The line quality can be kept at a certain level by repeating the above operation.

Second, the line quality monitoring section acquires performance information that is output every prescribed period of time, and the line quality setting section sets the line quality to a certain level according to the signal-to-noise ratio margin value, attenuation factor, interleave delay, interleave correction time, access speed, and performance information that are acquired by the line quality monitoring section. The use of the performance information further increases the line quality.

The performance information is information that is acquired every 15 minutes or 24 hours, for example, by counting the number of CRC errors, loss-of-signal (LOS) events, or loss-of-frame (LOF) events when they have occurred at least once in one second.

Third, the line quality monitoring section acquires a signal-to-noise ratio margin value, an attenuation factor, an interleave delay, an interleave correction time, and an access on a regular basis and employs those as statistical information in a predetermined fixed period. The line quality setting section sets a signal-to-noise ratio margin value, an attenuation factor, an interleave delay, an interleave correction time, and an access speed for a line to connect the user side and the center side according to the signal-to-noise ratio margin value, attenuation factor, interleave delay, interleave correction time, and access speed that are acquired as the statistical information.

This further increases the line quality because line quality is set on the basis of statistical information rather than instantaneous values.

Fourth, the line quality monitoring section acquires, as statistical information in a predetermined fixed period, a signal-to-noise ratio margin value, an attenuation factor, an interleave delay, an interleave correction time, an access speed, and a line alarm that is generated when signal transmission is disabled. The line quality setting section sets a signal-to-noise ratio margin value, an attenuation factor, an interleave delay, an interleave correction time, and an access speed for a line to connect the user side and the center side according to the signal-to-noise ratio margin value, attenuation factor, interleave delay, interleave correction time, access speed, and line alarm that are acquired as the statistical information.

This further increases the line quality because line quality is set by taking the line alarm into consideration.

Fifthly, the line quality monitoring section acquires, as statistical information in a predetermined fixed period, a signal-to-noise ratio margin value, an attenuation factor, an interleave delay, an interleave correction time, an access speed, performance information that is output every prescribed period of time, and a line alarm that is generated when signal transmission is disabled. The line quality setting section sets a signal-to-noise ratio margin value, an attenuation factor, an interleave delay, an interleave correction time, and an access speed for a line to connect the user side and the center side according to the signal-to-noise ratio margin value, attenuation factor, interleave delay, interleave correction time, access speed, performance information that is output every prescribed period of time, and line alarm that are acquired as the statistical information.

This further increases the line quality because line quality is set by taking the performance information and the line alarm into consideration.

Sixthly, in an xDSL transmission system selection apparatus in which a user side and a center side are line-connected to each other by a two-wire telephone circuit and an xDSL communications technology and are thereby allowed to communicate with each other, a line quality monitoring section acquires a signal-to-noise ratio margin value, an attenuation factor, an interleave delay, an interleave correction time, and an access speed. A transmission system selection section selects one transmission system from a plurality of transmission systems according to the acquired signal-to-noise ratio margin value, attenuation factor, interleave delay, interleave correction time, and access speed.

This makes it possible to select a proper transmission system.

Seventhly, the line quality monitoring section acquires performance information that is output every prescribed period of time in addition to the signal-to-noise ratio margin value, attenuation factor, interleave delay, interleave correction time, and access speed. The transmission system selection section selects one transmission system from a plurality of transmission systems according to the signal-to-noise ratio margin value, attenuation factor, interleave delay, interleave correction time, access speed, and performance information. The use of the performance information further increases the line quality.

The performance information is information that is acquired every 15 minutes or 24 hours, for example, by counting the number of CRC errors, loss-of-signal (LOS) events, or loss-of-frame (LOF) events when they have occurred at least once in one second.

Eighthly, the line quality monitoring section acquires a signal-to-noise ratio margin value, an attenuation factor, an interleave delay, an interleave correction time, and an access speed as statistical information in a predetermined fixed period. The transmission system setting section selects one transmission system from a plurality of transmission systems according to the signal-to-noise ratio margin value, attenuation factor, interleave delay, interleave correction time, and access speed that are acquired as the statistical information.

This makes it possible to select a proper transmission system because line quality is set on the basis of statistical information rather than instantaneous values.

Ninthly, the line quality monitoring section acquires, as statistical information in a predetermined fixed period, a signal-to-noise ratio margin value, an attenuation factor, an interleave delay, an interleave correction time, an access speed, and a line alarm that is generated when signal transmission is disabled. The transmission system setting section selects one transmission system from a plurality of transmission systems according to the signal-to-noise ratio margin value, attenuation factor, interleave delay, interleave correction time, access speed, and line alarm that are acquired as the statistical information.

This makes it possible to select a proper transmission system because line quality is set by taking the line alarm into consideration.

Tenthly, the line quality monitoring section acquires, as statistical information in a predetermined fixed period, a signal-to-noise ratio margin value, an attenuation factor, an interleave delay, an interleave correction time, an access speed, performance information that is output every prescribed period of time, and a line alarm that is generated when signal transmission is disabled. The transmission system setting section selects one transmission system from a plurality of transmission systems according to the signal-to-noise ratio margin value, attenuation factor, interleave delay, interleave correction time, access speed, performance information that is output every prescribed period of time, and line alarm that are acquired as the statistical information.

This makes it possible to select a proper transmission system because line quality is set by taking the performance information and the line alarm into consideration.

Eleventhly, in an xDSL line quality monitoring apparatus in which a user side and a center side are line-connected to each other by a two-wire telephone circuit and an xDSL communications technology and are thereby allowed to communicate with each other, a line quality monitoring section acquires, during the line connection, a signal-to-noise ratio margin value, an attenuation factor, an interleave delay, an interleave correction time, an access speed, and performance information that is output every prescribed period of time.

This allows the line quality monitoring section to perform line monitoring taking the performance information into consideration. The performance information is information that is acquired every 15 minutes or 24 hours, for example, by counting the number of CRC errors, loss-of-signal (LOS) events, or loss-of-frame (LOF) events when they have occurred at least once in one second.

Twelthly, the line quality monitoring section acquires a signal-to-noise ratio margin value, an attenuation factor, an interleave delay, an interleave correction time, and an access speed as statistical information in a predetermined fixed period.

This makes it possible to perform line monitoring on the basis of statistical information.

Thirteenthly, the line quality monitoring section acquires, as statistical information in a predetermined fixed period, a line alarm that is generated when signal transmission is disabled.

This makes it possible to monitor the line quality taking the line alarm into consideration.

Fourteenthly, the line quality monitoring section acquires, as statistical information in a predetermined fixed period, a signal-to-noise ratio margin value, an attenuation factor, an interleave delay, an interleave correction time, an access speed, performance information that is output every predetermined time, and a line alarm that is generated when signal transmission is disabled.

This makes it possible to monitor the line quality with the performance information and the line alarm taken into consideration.

### BRIEF DESCRIPTION OF THE DRAWINGS

FIG. 1 shows a basic configuration of an xDSL-based communications technology in which user-side apparatus and a center-side apparatus are connected to each other for mutual communication via two-wire telephone lines used in the present invention;

FIG. 2 is a block diagram outlining a center-side DSL communication apparatus;

FIG. 3 is an exemplary flowchart of a process that is executed by a line quality setting circuit to obtain proper line quality;

FIG. 4 is a block diagram outlining a center-side DSL communication apparatus;

FIG. 5 is an exemplary flowchart showing an exemplary process of the DSL communication apparatus of FIG. 4; and

FIG. 6 is a graph illustrating differences between transmission systems in the relationship between the distance and the transmission rate.

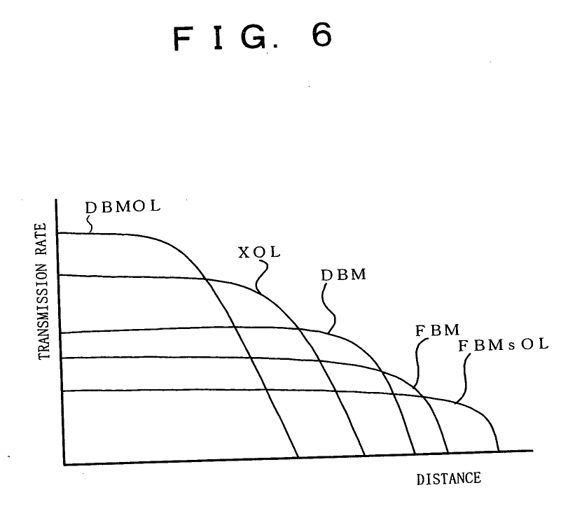

### BEST MODE FOR CARRYING OUT THE INVENTION

Embodiments of the present invention will be hereinafter described.

### Embodiment 1

A first embodiment of the invention will be described below.

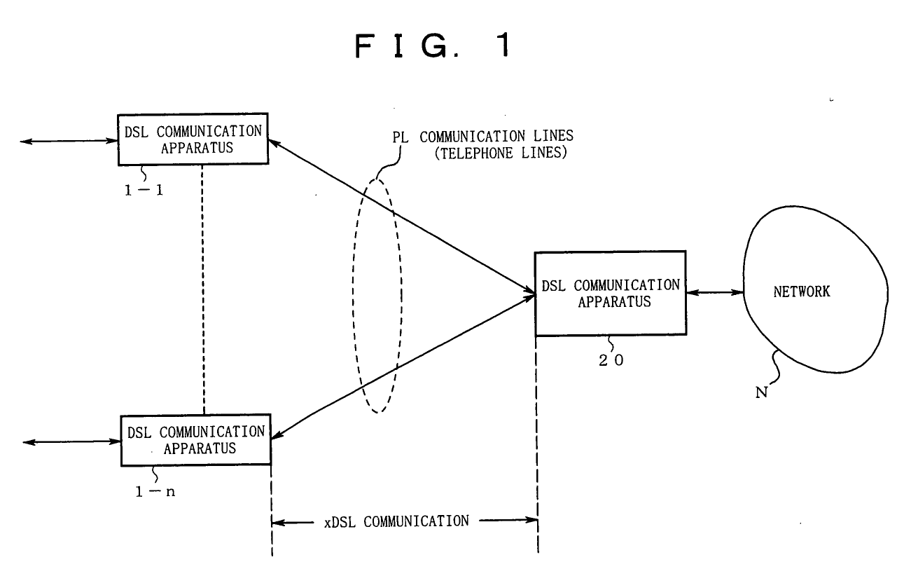

FIG. 1 shows a basic configuration of an xDSL-based communications technology in which user-side DSL communication apparatus 1-1 to 1-n and a center-side DSL communication apparatus 20 are connected to each other via two-wire communication lines (telephone lines) PL used in the invention and are thereby allowed to communicate with each other.

As shown in FIG. 1, the plural communication lines PL connect the respective user-side DSL communication apparatus 1-1 to 1-n to the center-side DSL communication apparatus 20 and are accommodated into the center-side DSL communication apparatus 20. The center-side DSL communication apparatus 20 is connected to a network N.

The user-side DSL communication apparatus 1-1 to 1-n are connected to respective terminal apparatus such as personal computers (not shown).

The communication lines PL which connect the respective user-side DSL communication apparatus 1-1 to 1-n to the center-side DSL communication apparatus 20 in FIG. 1 serve for xDSL communications.

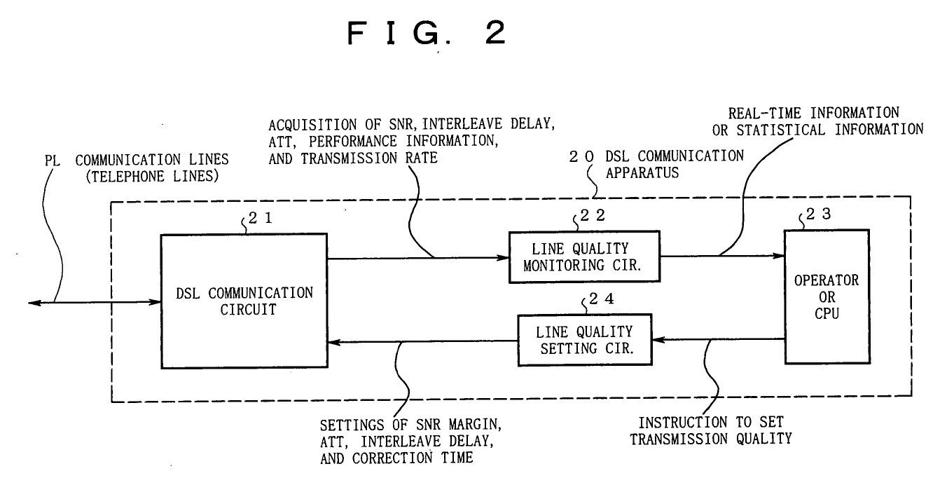

FIG. 2 is a block diagram of an example of the DSL communication apparatus (1-1 to 1-n and 20) shown in FIG. 1. The DSL communication apparatus 1-1 to 1-n and the DSL communication apparatus 20 have the same configuration, and the example of FIG. 2 will be described as being the DSL communication apparatus 20.

As shown in FIG. 2, the DSL communication apparatus 20 is composed of a DSL communication circuit 21, a line quality monitoring circuit 22, a CPU (or operator) 23, and a line quality setting circuit 24.

The DSL communication circuit 21 is connected to the communication line (telephone line) PL. The line quality monitoring circuit 22 acquires a signal-to-noise ratio (SNR), an interleave delay, an attenuation factor (ATT), performance information, and a transmission rate from the DSL communication circuit 21. The DSL communication circuit 21 acquires instantaneous values of the signal-to-noise ratio (SNR) etc. and acquires, as statistical information, average values every time a fixed time elapses.

For example, assume that performance information occurs every 15 minutes or 24 hours. The DSL communication circuit 21 increments the number of CRC errors if a CRC error occurs even only once in one second. The DSL communication circuit 21 operates in the same manner also for loss-of-signal (LOS) and loss-of-frame (LOF). When acquiring statistical information, the line quality monitoring circuit 22 incorporates, into the statistical information, the number of times of occurrence of CRC errors, the number of times of occurrence of a loss-of-signal (LOS) event, and the number of times of occurrence of a loss-of-frame (LOF) event (performance information) that have been acquired every 15 minutes or 24 hours.

Receiving the real-time information or statistical information, the CPU (or operator) 23 supplies the real-time information or statistical information to the line quality setting circuit 24 and instructs it to set a proper transmission environment.

The line quality setting circuit 24 sets line quality (SNR margin, ATT, interleave delay, and interleave correction time) for the DSL communication circuit 21 according to the above instruction.

Proper line quality may be set on the basis of either real-time information or statistical information.

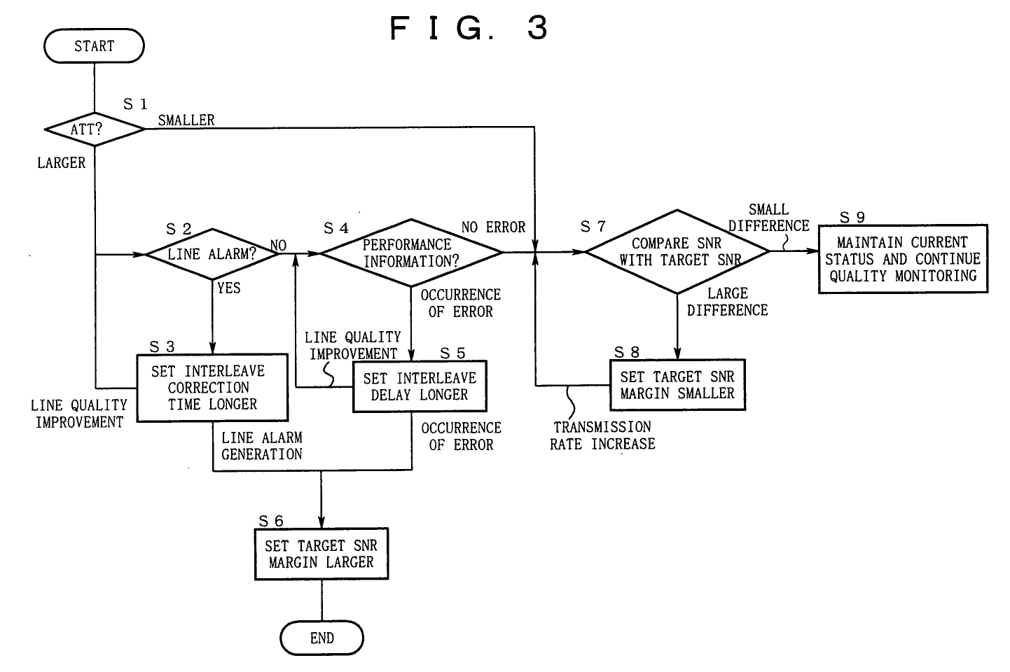

FIG. 3 is an exemplary flowchart of a process that is executed by the line quality setting circuit 24 to obtain proper line quality.

At step S1, it is judged whether the attenuation factor (ATT) is smaller or larger than a predetermined value. If it is judged that the attenuation factor is larger, the process moves to step S2.

At step S2, it is judged whether or not a line alarm is being output. A line alarm is output in the following case. For example, a line alarm is generated when a loss-of-signal (LOS) event or a loss-of-frame (LOF) event has occurred in the DSL communication circuit 21. This is because loss of a signal or a frame incorporating plural signals during a transmission using xDSL makes the signal transmission impossible. A line alarm is output in such a case.

If it is judged at step S2 that a line alarm is being generated, the process moves to step S3, where the interleave correction time is set longer. As a result, the error correction time is increased, whereby a loss-of-signal event or the like does not occur and the line quality is increased. If the output of the line alarm is stopped as a result of the execution of step S3, the process returns to step S2, where whether or not a line alarm is being output is judged again for confirmation.

If the output of the line alarm is not stopped even after the execution of step S3, the process moves to step S6. At step S6, the target SNR margin time is set larger. This makes it possible to avoid a loss-of-signal event or the like though the transmission rate is lowered.

In this flowchart, the judgment as to whether or not a line alarm is being output, which accompanies step S3, is omitted for the sake of simplicity.

If it is judged at step S2 that a line alarm is not being output, the process moves to step S4.

At step S4, performance information is monitored. As mentioned above, performance information is output at a rate of once per 15 minutes or 24 hours, for example. In this manner, a CRC error, a loss-of-signal (LOS) event, and a loss-of-frame (LOF) event are monitored on a regular basis.

If it is found as a result of the monitoring at step S4 that a CRC error, a loss-of-signal (LOS) event, or a loss-of-frame (LOF) event has occurred, the process moves to step S5.

At step S5, the interleave delay is set longer. More specifically, the capacity of a memory for signal storage is increased. This eliminates a loss-of-signal event or the like, improving the line quality. When the execution of step S5 can prevent the occurrence of an error, the line quality and rate is increased. Then, the process returns to step S4, where performance information is monitored again for confirmation.

If a CRC error, a loss-of-signal (LOS) event, or a loss-of-frame (LOF) event occurs even after the execution of step S5, the process moves to step S6.

At step S6, as described above, the target SNR margin time is set larger. This makes it possible to avoid a loss-of-signal event or the like though the transmission rate is lowered.

In this flowchart, the judgment as to whether an error has occurred in monitoring of performance information, which accompanies step S5, is omitted for the sake of simplicity.

If it is found as a result of the monitoring at step S4 that no CRC error, loss-of-signal (LOS) event, or loss-of-frame (LOF) event has occurred, the process moves to step S7. The process also moves to step S7 if it is judged at step S1 that the attenuation factor (ATT) is smaller than the predetermined value.

At step S7, the signal-to-noise ratio (SNR) is compared with a target signal-to-noise ratio (SNR). If the comparison shows that their difference ((signal-to-noise ratio (SNR))<(target signal-to-noise ratio (SNR))) is large, the process moves to step S8, where the target signal-to-noise ratio (SNR) is set smaller. As a result, the transmission rate is increased. If the comparison shows that they have almost no difference, the process moves to step S9.

At step S9, the current status is maintained and the quality monitoring is continued.

As is apparent from the above description, according to the first embodiment, the xDSL line quality can be set so as to fall within a prescribed range on the basis of information acquired by the line quality monitoring circuit 22 shown in FIG. 2.

In the first embodiment, a proper signal-to-noise ratio (SNR) margin, a proper attenuation factor (ATT), a proper interleave delay, and a proper correction time are determined by the line quality setting circuit 24. However, the invention is not limited to such a case. The CPU 23 may determine those values.

### Embodiment 2

Next, a second embodiment of the invention will be described.

The second embodiment employs the same basic configuration of an xDSL communications technology as shown in FIG. 1, and hence a description therefor will be omitted.

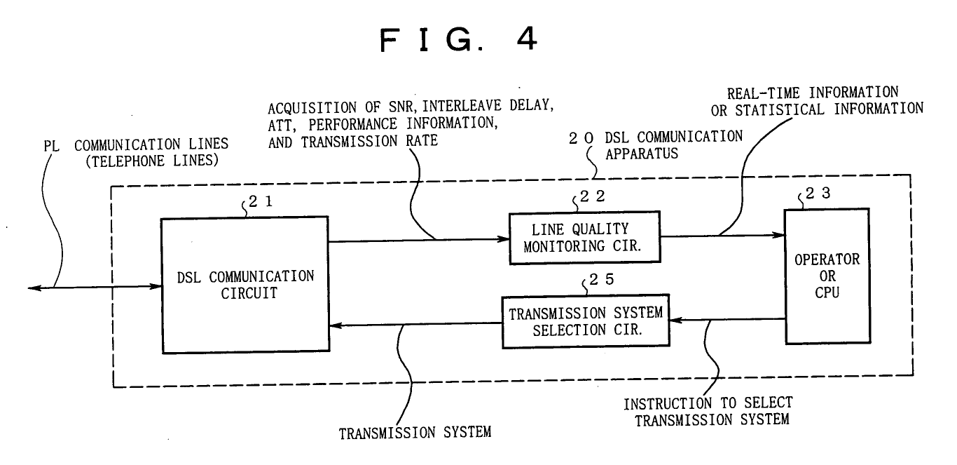

FIG. 4 is a block diagram of an example of the DSL communication apparatus (1-1 to 1-n and 20) shown in FIG. 1. The DSL communication apparatus 1-1 to 1-n and the DSL communication apparatus 20 have the same configuration, and the example of FIG. 4 will be described as being the DSL communication apparatus 20.

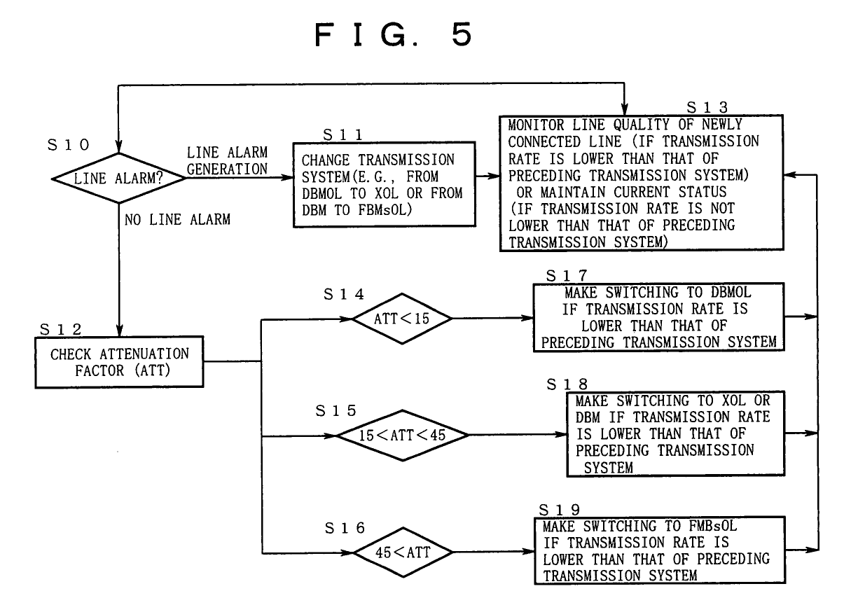

Further, components of the DSL communication apparatus 20 shown in FIG. 4 having the same components in the DSL communication apparatus 20 shown in FIG. 2 will be given the same reference symbols and will not be described. More specifically, the only one difference therein is that the transmission system selection circuit 25 of FIG. 5 is substituted for the line quality setting circuit 24 of FIG. 3.

Referring to FIG. 4, receiving real-time information or statistical information, the CPU (or operator) 23 instructs the transmission system selection circuit 25 to select a transmission system on the basis of the real-time information or statistical information. The transmission system selection circuit 25 selects a transmission system on the basis of the real-time information or statistical information, and instructs the DSL communication circuit 21 to set the selected transmission system.

FIG. 5 is an exemplary flowchart of a process that is executed by the transmission system selection circuit 25 to select a proper transmission system.

At step S10, it is judged whether or not a line alarm is being output. A line alarm is output in the following case. That is, a line alarm is generated when a loss-of-signal (LOS) event or a loss-of-frame (LOF) event has occurred in the DSL communication circuit 21. This is because loss of a signal or a frame incorporating plural signals during a transmission using xDSL makes the signal transmission impossible.

If it is judged at step S10 that a line alarm is being generated, the process moves to step S11.

At step S11, the transmission system is changed. For example, switching is made to XOL if the current transmission system is DBMOL, and to FBMsOL if the current transmission system is DBM. Then, the process moves to step S13 from step S11.

At step S13, the line quality of a newly set line is monitored.

If it is judged at step S10 that no line alarm is being output, the process moves to step S12.

At step S12, the attenuation factor (ATT) is checked. The process moves to step S14, S15, or S16 depending on the magnitude (db) of the checked attenuation factor (ATT).

That is, if the attenuation factor (ATT) is smaller than 15 db, the judgment result of step S14 is affirmative. Then, at step S17, switching is made to DBMOL, for example, if the transmission rate is lower than that of the preceding transmission system.

If the attenuation factor (ATT) is in a range of 15 to 45 db, the judgment result of step S15 is affirmative. Then, at step S18, switching is made to XOL or DBM, for example, if the transmission rate is lower than that of the preceding transmission system.

If the attenuation factor (ATT) is larger than 45 db, the judgment result of step S16 is affirmative. Then, at step S19, switching is made to FMBsOL, for example, if the transmission rate is lower than that of the preceding transmission system.

If it is judged at step S17, S18, or S19 that the transmission rate is lower than that of the preceding transmission system, the line quality of a connected line is monitored at step S13.

If it is judged at step S17, S18, or S19 that the transmission rate is higher than that of the preceding transmission system, the current transmission system continues to be employed at step S13.

As is apparent from the above description, according to the second embodiment, the transmission system selection circuit 25 selects a proper transmission system on the basis of information acquired by the line quality monitoring circuit 22 shown in FIG. 4 and cause the DSL communication circuit 21 to employ it.

In the second embodiment, a proper transmission system is selected by the transmission system selection circuit 25. However, the invention is not limited to such a case. The CPU 23 may select a proper transmission system.

### INDUSTRIAL APPLICATION

According to the invention, in xDSL in which a user and a center are connected to each other via a two-wire telephone line and are thereby allowed to communicate with each other, the following items are monitored in addition to the signal-to-noise ratio (SNR) margin and the signal attenuation factor (ATT): interleave delay (complexity of error correction), interleave correction time (error correction time), CRC error, loss-of-signal (LOS) event, loss-of-frame (LOF) event (these three items are monitored on a regular basis), and transmission rate. This makes it unnecessary to increase the line quality and the transmission rate and select an optimum transmission system without the need for negotiating with a cooperating user-side or center-side apparatus, that is, by a judgment of an apparatus on one side.

The invention can be implemented by altering only software (firmware) (i.e., no hardware alterations are necessary). Therefore, it is possible to operate only a user-side apparatus independently according to the invention. Problems relating to interconnectivity between a user-side apparatus and a center-side apparatus can be solved. Further, an apparatus can be constructed at a low cost and hence cost-related problems can be overcome.

1. An xDSL line quality control apparatus in which a user side and a center side are line-connected to each other for mutual communication by a two-wire telephone circuit and an xDSL communications technology, comprising:
a line quality monitoring section that acquires a signal-to-noise ratio margin value, an attenuation factor, an interleave delay, an interleave correction time, and a transmission speed during the line connection; and
a line quality setting section that sets a signal-to-noise ratio margin value, an attenuation factor, an interleave delay, an interleave correction time, and a transmission speed for a line to connect said user side and said center side, according to the acquired signal-to-noise ratio margin value, said attenuation factor, said interleave delay, said interleave correction time, and said transmission speed, to set quality of the line.

2. The xDSL line quality control apparatus according to claim 1, wherein:
said line quality monitoring section acquires performance information in addition to said signal-to-noise ratio margin value, said attenuation factor, said interleave delay, said interleave correction time, and said transmission speed, the performance information being output every prescribed period of time; and
said line quality setting section sets the line quality to a level according to said signal-to-noise ratio margin value, said attenuation factor, said interleave delay, said interleave correction time, said transmission speed, and said performance information.

3. The xDSL line quality control apparatus according to claim 2, wherein said performance information is acquired every 15 minutes or 24 hours by counting a number of CRC errors, loss-of-signal (LOS) events, or loss-of-frame (LOF) events when they have occurred at least once in one second.

4. The xDSL line quality control apparatus according to claim 1, wherein:
said line quality monitoring section acquires said signal-to-noise ratio margin value, said attenuation factor, said interleave delay, said interleave correction time, and said transmission speed as statistical information in a predetermined fixed period; and
said line quality setting section sets said signal-to-noise ratio margin value, said attenuation factor, said interleave delay, said interleave correction time, and said transmission speed for a line to connect said user side and said center side, according to said signal-to-noise ratio margin value, said attenuation factor, said interleave delay, said interleave correction time, and said transmission speed acquired as said statistical information.

5. The xDSL line quality control apparatus according to claim 1, wherein:
said line quality monitoring section acquires, as statistical information in a predetermined fixed period, said signal-to-noise ratio margin value, said attenuation factor, said interleave delay, said interleave correction time, said transmission speed, and a line alarm, the line alarm being generated when signal transmission is disabled; and
said line quality setting section sets said signal-to-noise ratio margin value, said attenuation factor, said interleave delay, said interleave correction time, and said transmission speed for a line to connect said user side and said center side, according to said signal-to-noise ratio margin value, said attenuation factor, said interleave delay, said interleave correction time, said transmission speed, and said line alarm acquired as said statistical information.

6. The xDSL line quality control apparatus according to claim 1, wherein:
said line quality monitoring section acquires, as statistical information in a predetermined fixed period, said signal-to-noise ratio margin value, said attenuation factor, said interleave delay, said interleave correction time, said transmission speed, performance information, and a line alarm, the performance information being output every prescribed period of time, the line alarm being generated when signal transmission is disabled; and
said line quality setting section sets said signal-to-noise ratio margin value, said attenuation factor, said interleave delay, said interleave correction time, and said transmission speed for a line to connect said user side and said center side, according to said signal-to-noise ratio margin value, said attenuation factor, said interleave delay, said interleave correction time, said transmission speed, said performance information, and said line alarm acquired as said statistical information, the performance information being output every prescribed period of time.

7. An xDSL transmission system selection apparatus in which a user side and a center side are line-connected to each other for mutual communication by a two-wire telephone circuit and an xDSL communications technology, comprising:
a line quality monitoring section that acquires a signal-to-noise ratio margin value, an attenuation factor, an interleave delay, an interleave correction time, and a transmission speed during said line connection; and
a transmission system selection section that selects one transmission system from a plurality of transmission systems according to the acquired signal-to-noise ratio margin value, said attenuation factor, said interleave delay, said interleave correction time, and said transmission speed.

8. The xDSL transmission system selection apparatus according to claim 7, wherein:
said line quality monitoring section acquires performance information in addition to said signal-to-noise ratio margin value, said attenuation factor, said interleave delay, said interleave correction time, and said transmission speed, the performance information being output every prescribed period of time; and
said transmission system selection section selects one transmission system from said plurality of transmission systems according to said signal-to-noise ratio margin value, said attenuation factor, said interleave delay, said interleave correction time, said transmission speed, and said performance information.

9. The xDSL transmission system selection apparatus according to claim 8, wherein said performance information is acquired every 15 minutes or 24 hours by counting a number of CRC errors, loss-of-signal (LOS) events, or loss-of-frame (LOF) events when they have occurred at least once in one second.

10. The xDSL transmission system selection apparatus according to claim 7, wherein:
said line quality monitoring section acquires said signal-to-noise ratio margin value, said attenuation factor, said interleave delay, said interleave correction time, and said transmission speed as statistical information in a predetermined fixed period; and
said transmission system selection section selects one transmission system from said plurality of transmission systems according to said signal-to-noise ratio margin value, said attenuation factor, said interleave delay, said interleave correction time, and said transmission speed that are acquired as said statistical information.

11. The xDSL transmission system selection apparatus according to claim 7, wherein:
said line quality monitoring section acquires, as statistical information in a predetermined fixed period, said signal-to-noise ratio margin value, said attenuation factor, said interleave delay, said interleave correction time, said transmission speed, and a line alarm, the line alarm being generated when signal transmission is disabled; and
said transmission system selection section selects one transmission system from said plurality of transmission systems according to said signal-to-noise ratio margin value, said attenuation factor, said interleave delay, said interleave correction time, said transmission speed, and said line alarm acquired as said statistical information.

12. The xDSL transmission system selection apparatus according to claim 7, wherein:
said line quality monitoring section acquires, as statistical information in a predetermined fixed period, said signal-to-noise ratio margin value, said attenuation factor, said interleave delay, said interleave correction time, said transmission speed, performance information, and a line alarm, the performance information being output every prescribed period of time, the line alarm being generated when signal transmission is disabled; and
said transmission system selection section selects one transmission system from said plurality of transmission systems according to said signal-to-noise ratio margin value, said attenuation factor, said interleave delay, said interleave correction time, said transmission speed, said performance information, and said line alarm acquired as said statistical information, the performance information being output every prescribed period of time.

13. An xDSL line quality monitoring apparatus in which a user side and a center side are line-connected to each other for mutual communication by a two-wire telephone circuit and an xDSL communications technology, comprising:
a line quality monitoring section that acquires, during the line connection, a signal-to-noise ratio margin value, an attenuation factor, an interleave delay, an interleave correction time, a transmission speed, and performance information, the performance information being output every prescribed period of time.

14. The xDSL line quality monitoring apparatus according to claim 13, wherein said performance information is acquired every 15 minutes or 24 hours by counting a number of CRC errors, loss-of-signal (LOS) events, or loss-of-frame events (LOF) when they have occurred at least once in one second.

15. The xDSL line quality monitoring apparatus according to claim 13, wherein said line quality monitoring section acquires said signal-to-noise ratio margin value, said attenuation factor, said interleave delay, said interleave correction time, and said transmission speed as statistical information in a predetermined fixed period.

16. The xDSL line quality monitoring apparatus according to claim 13, wherein said line quality monitoring section acquires a line alarm as statistical information in a predetermined fixed period, the line alarm being generated when signal transmission is disabled.

17. The xDSL line quality monitoring apparatus according to claim 13, wherein said line quality monitoring section acquires, as statistical information in a predetermined fixed period, said signal-to-noise ratio margin value, said attenuation factor, said interleave delay, said interleave correction time, said transmission speed, said performance information, and a line alarm, the performance information being output every predetermined time, the line alarm being generated when signal transmission is disabled.
